(19) United States
(12) Patent Application Publication
(10) Pub. No.: US 2014/0335274 A1
(43) Pub. Date: Nov. 13, 2014

(54) Deposition of Nano-Diamond Particles

(71) Applicants: IMEC, Leuven (BE); UNIVERSITEIT HASSELT, Hasselt (BE)

(72) Inventors: Thijs Vandenryt, Leuven (BE); Lars Grieten, Leuven (BE); Ward De Ceuninck, Leuven (BE); Ronald Thoelen, Leuven (BE); Michaël Daenen, Leuven (BE); Patrick Wagner, Leuven (BE)

(73) Assignees: UNIVERSITEIT HASSELT, Diepenbeek (BE); IMEC, Leuven (BE)

(21) Appl. No.: 14/361,377

(22) PCT Filed: Nov. 29, 2012
(86) PCT No.: PCT/EP2012/074003

§ 371 Date: May 29, 2014

Related U.S. Application Data
(60) Provisional application No. 61/564,564, filed on Nov. 29, 2011.

(51) Int. Cl. C01B 31/06; B05D 1/32

(52) U.S. Cl. CPC C01B 31/06; B05D 1/32
USPC 427/283

(57) ABSTRACT

The present invention relates to a method (1) for creating a diamond structure (38) on a substrate (31). This method comprises the steps of providing (2) a substrate (31), providing (3) a mold (25) on the substrate (31), providing (4) a diamond seed solution (34) in the mold (25), and removing (6) the mold (25) such that a diamond structure (38) remains on the substrate (31).

### FIELD OF THE INVENTION

The invention relates to the field of nano-diamond deposition. More specifically it relates to a method for creating a diamond structure on a substrate.

### BACKGROUND OF THE INVENTION

Synthetic diamond is widely applied in materials science, for example for tool coating, in electrochemistry, for example for water purification and detection of compounds, in biosensing, e.g. for protein and DNA detection, and in electronics, e.g. for micro-electromechanical devices and high-power-high-frequency systems. Due to its remarkable physical, mechanical and electronic properties, and suitability for doping, it is an exotic material offering a large potential for competing with traditional silicon substrates. Advantageous properties include a high Young modulus, good semiconductor properties, a high thermal conductivity, transparency, inertness and biocompatibility. Therefore, such diamond structures may find application in MEMS, electronics, heat spreaders, sensor surfaces, e.g. biosensors, functional coatings, and medical applications.

However, technology demands downsizing of diamond patterns to small structures, e.g. in the micrometer to nanometer range, for many areas of application. In order to create diamond films, a substrate, e.g. Si, SiOx, metal, quartz or other substrate material, is seeded with nano-diamonds, and exposed to a microwave enhanced plasma or hot filament system to allow the growth of a continuous film, see FIG. 1, which shows, from left to right, a scanning electron microscopy (SEM) image of the substrate seeded with nano-diamonds, a SEM image of a synthetic diamond layer grown on such seeded surface, and a photograph of a 2″ diamond film.

The patterning of diamond can be achieved by pre-growth approach known in the art, in which a selective area is deposited (SAD) with diamond seeds from which a diamond structure can be grown. Known pre-growth techniques which may be used are lithography combined with lift-off, or inkjet printing. These techniques may require photolithography/electron-beam equipment and optionally cleanrooms, and may further require sample treatment on an individual sample basis. Although these techniques may be time-saving, they can be considered relatively expensive. Furthermore, these techniques may have the disadvantages of a significant chance of reseeding and risk of contamination due to polymers and solvents. Therefore, these pre-growth techniques may result in poorly defined structures.

Alternatively, in a post-growth approach, hard-masks may be used to enable selective diamond etching in oxygen-plasma. Post-growth techniques may require vacuum plasma systems, photolithography/electron-beam equipment, sputtering systems and cleanrooms, and also may require individual sample treatment steps. Although these techniques may result in small-scale structures, they may be very time-consuming and relatively expensive. Furthermore, these techniques may comprise multi-step processes with large error margins, may require specific alignments per sample, and may result in disadvantageous etch effects on the manufactured structures.

The most interesting prior-art procedure to construct small specific diamond patterns for device preparation may be the pre-growth treatment approach. Especially regarding the aspect of time-saving and requirements for specialised equipment and materials, this approach can be considered to be the most favourable one. However, known pre-growth techniques still lack important features such as the ability to produce reproducible well-defined structures, high-throughput synthesis, a low production cost per sample and usability without specialized personnel.

Furthermore, although other methods may be known in the art which feature a shorter and easier processing, these may involve a disadvantageous trade-off in terms of the achievable resolution of the patterned diamond.

Williams et al. developed a procedure to improve the nucleation density of the NCD which comprises seeding a substrate with a suspension of detonation diamond. In order to produce patterned diamond structures, a lithographical procedure is indispensable. However, Bongrain et al. have shown two selective seeding alternatives to the conventional etching approach. Unfortunately both techniques require extensive sample preparation and complex pre/post-nucleation treatment steps.

There are a lot of methods which have been tested and presented, and currently, techniques based on post-growth processing by etching may be particularly popular. For example, a method, reported by A. Bongrain et al. in 2009, has been chosen as benchmark, to which other techniques are compared. Three widely employed processes were selected to be discussed in detail: (1) etching technique, (2) lift-off technique (A. Bongrain et al. 2009) and (3) micro contact printing technique, (developed by Hao Zhuang, 2011).

These methods are demonstrated in FIG. 16. The classic method and solution 1 are inspired by the methods used in the electronics industry to pattern silicon. The first, and most-widely spread, approach involves: 1) Cleaning the substrate, 2) Dip coating in nano-diamond solution and growing of a diamond film in a microwave or hot filament reactor (vacuum), 3) Sputtering of a metal layer (vacuum), 4) Spin-coating resist on top of the metal layer, 5) Pattern the resist, 6) Etch the protective metal layer, 7) Etch the diamond with oxygen-plasma (vacuum), 8) Removal of metal mask and cleaning of diamond on substrate.

Solution 1 uses a lift-off technique: 1) cleaning the substrate, 2) spincoating photoresist, 3) Depositing diamond seeds, 4) Lift-off of seeds in undesired locations, 5) Grow the diamond in a diamond reactor (Vacuum).

Solution 2 is based around micro contact printing: a PDMS stamp is used to transfer a pattern onto a substrate: 1) Cleaning the substrate, 2) spincoating a thin layer of PMMA, 3) Heating of the PMMA to the glass transition temperature, 4) Imprinting the PMMA layer with the PDMS stamp (coated in nano-diamond), 5) Etch away the PMMA while growing the diamond an a reactor (vacuum).

The first state-of-the-art method (Solution 1) employs a lift-off step after the sample has been seeded with mono-dispersed nano-diamond. The second (Solution 2) presented by Hao Zhuang and published in August 2011, uses PDMS as a stamp for micro-contact printing of the nano-diamond solution. This procedure requires an additional PMMA layer to be spincoated and relies on the plasma of the diamond reactor to burn of the layer of PMMA, and dropping the seeds onto the substrate (causing reseeding and contamination).

The classic method offers great resolution, at the cost of speed, risk to damage the substrate and economical disadvantages. Edge definition is usually less good, as illustrated in FIG. 17.

State of the art solution 1 offers speed and cost reduction as main advantages when compared to the classic method. Disadvantages are the requirement of a spin-coating/lift-off step, a possible loss in resolution and high probability of reseeding during lift-off.

Solution 2 is fast and only requires a spincoating step. But this method has a high probability of reseeding when printing high resolution structures and seed density is limited. Large-scale automation of this procedure can be cumbersome.

Several other techniques can be found in literature, including ink-jet printing of the nano-diamond suspension, bias enhanced nucleation, photo-resist/nano-diamond mix to be spin-coated and etched away, etc. But most of these techniques lack the resolution, economical, time-consumability and/or are very vulnerable to reseeding.

### SUMMARY OF THE INVENTION

It is an object of embodiments of the present invention to provide a good diamond structure on a substrate.

The above objective is accomplished by a method and device according to the present invention.

Aspects of the present invention provide a method for creating a diamond structure on a substrate. This method comprises the steps of providing a substrate, providing a mold on the substrate, providing a diamond seed solution in the mold, and removing the mold such that a diamond structure remains on the substrate. It is an advantage of embodiments of the present invention that a very fast method is provided. It is a further advantage of embodiments of the present invention that a method is provided which does not require additional preparation steps.

In embodiments of the present invention, the method may further comprise the steps of drying the diamond seed solution before removing the mold from the substrate.

In embodiments of the present invention, the method may further comprise growing a diamond structure in a reactor.

In embodiments of the present invention, providing a mold on the substrate may comprise providing a mold comprising at least one microfluidic channel for contacting the diamond seed solution to the substrate.

In embodiments of the present invention, providing the diamond seed solution may comprise pumping the diamond seed solution through at least one microfluidic channel formed in said mold.

In embodiments of the present invention, providing a diamond seed solution in the mold may comprise providing a diamond seed solution in a mold comprising at least one microfluidic channel adapted for spontaneous surface tension confined capillary pumping of the diamond seed solution.

In embodiments of the present invention, providing the diamond seed solution may comprise transporting the diamond seed solution through at least one microfluidic channel formed in the mold by applying suction.

In embodiments of the present invention, providing the mold on the substrate may comprise covering the mold by the substrate to avoid leakage of the diamond seed solution from the mold.

In embodiments of the present invention, the method may further comprise a step of creating holes in the mold to create inlets and outlets for the diamond seed solution to be introduced in the mold.

In embodiments of the present invention, the method may furthermore comprise fabricating the mold. The fabrication may comprise the steps of obtaining a master mold comprising a structure pattern, depositing a flexible material atop the structure pattern, and removing the flexible material from the master mold.

In embodiments of the present invention, obtaining a master mold may comprise providing a master substrate, depositing a photo-resist layer atop the master substrate and patterning said structure in the photo-resist layer.

It is an advantage of embodiments of the present invention that good resolution of patterned diamond structures can be achieved.

It is an advantage of embodiments of the present invention that a low probability of reseeding can be attained.

It is an advantage of embodiments of the present invention that a high diamond seed density can be achieved.

It is an advantage of embodiments of the present invention that the manufacturing of diamond on a substrate may be fairly automated and may achieve a high throughput.

Particular and preferred aspects of the invention are set out in the accompanying independent and dependent claims. Features from the dependent claims may be combined with features of the independent claims and with features of other dependent claims as appropriate and not merely as explicitly set out in the claims.

These and other aspects of the invention will be apparent from and elucidated with reference to the embodiment(s) described hereinafter.

### BRIEF DESCRIPTION OF THE DRAWINGS

FIG. 1 shows, from left to right, a SEM image of a seeded surface, a SEM image of a synthetic diamond structure grown on such seeded surface, and a photograph of a 2″ diamond film, according to techniques known in the art.

FIG. 2 illustrates the manufacture of a master mold for use in an exemplary method according to embodiments of the present invention.

FIG. 3 illustrates the manufacture of a mold for use in an exemplary method according to embodiments of the present invention.

FIG. 4 illustrates an exemplary method according to embodiments of the present invention.

FIG. 5 shows a scanning electron microscopy (SEM) recording obtained for a sub-millimeter structure manufactured according to embodiments of the present invention.

FIG. 6 shows a confocal fluorescence microscopy (CFM) recording obtained for a sub-millimeter structure manufactured according to embodiments of the present invention.

FIG. 7 shows an optical microscopy (OM) recording obtained for a sub-millimeter structure manufactured according to embodiments of the present invention.

FIG. 8 shows a SEM image of a 1 mm long NCD obtained according to embodiments of the present invention.

FIG. 9 shows a diamond lane with a width of 17 μm obtained according to embodiments of the present invention.

FIG. 10 shows a detail image of the well-defined edge of the diamond lane shown in FIG. 9, according to embodiments of the present invention.

FIG. 11 shows a lane of 12 μm width, obtained according to embodiments of the present invention.

FIG. 12 shows a lane of 5 μm width, obtained according to embodiments of the present invention.

FIG. 13 shows a lane of 2 μm width, obtained according to embodiments of the present invention.

FIG. 14 shows a 600 nm NCD, obtained with a method according to embodiments of the present invention.

FIG. 15 shows diamond lanes of 150 nm as obtained by a method according to embodiments of the present invention.

FIG. 16 illustrates three relates prior art methods.

FIG. 17 shows a electron microscopy image for the result obtained from a conventional prior art method based on photolithography.

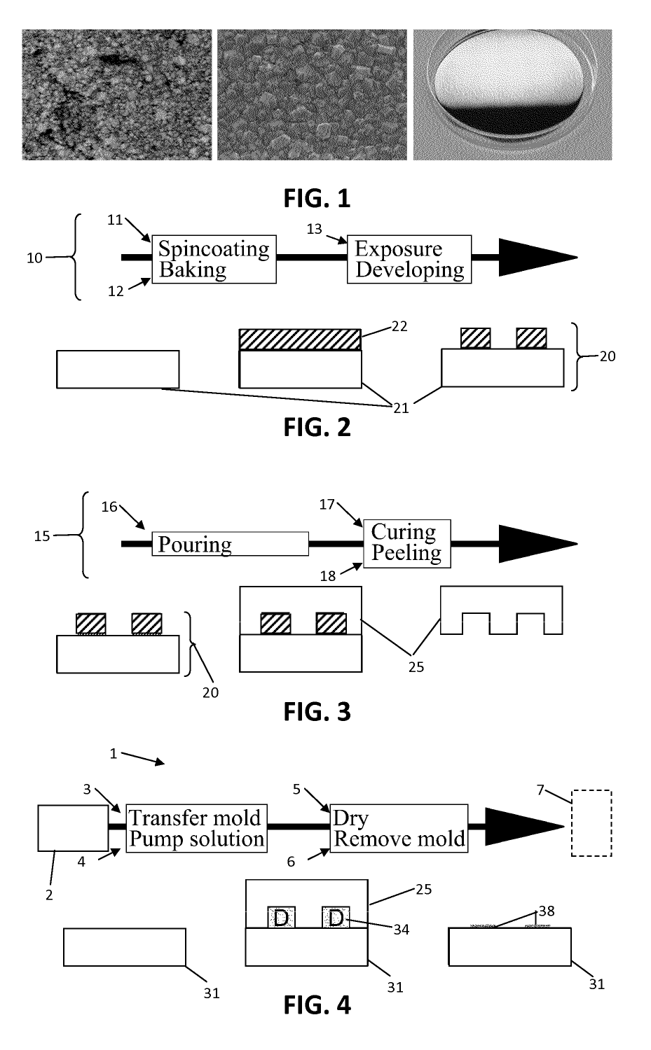

The drawings are only schematic and are non-limiting. In the drawings, the size of some of the elements may be exaggerated and not drawn on scale for illustrative purposes.

Any reference signs in the claims shall not be construed as limiting the scope.

In the different drawings, the same reference signs refer to the same or analogous elements.

### DETAILED DESCRIPTION OF ILLUSTRATIVE EMBODIMENTS

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes. The dimensions and the relative dimensions do not correspond to actual reductions to practice of the invention.

The terms first, second and the like in the description and in the claims, are used for distinguishing between similar elements and not necessarily for describing a sequence, either temporally, spatially, in ranking or in any other manner. It is to be understood that the terms so used are interchangeable under appropriate circumstances and that the embodiments of the invention described herein are capable of operation in other sequences than described or illustrated herein.

Moreover, the terms top, under and the like in the description and the claims are used for descriptive purposes and not necessarily for describing relative positions. It is to be understood that the terms so used are interchangeable under appropriate circumstances and that the embodiments of the invention described herein are capable of operation in other orientations than described or illustrated herein.

It is to be noticed that the term “comprising”, used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B. It means that with respect to the present invention, the only relevant components of the device are A and B.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the detailed description are hereby expressly incorporated into this detailed description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

In the description provided herein, numerous specific details are set forth. However, it is understood that embodiments of the invention may be practiced without these specific details. In other instances, well-known methods, structures and techniques have not been shown in detail in order not to obscure an understanding of this description.

In a first aspect, the present invention relates to a method for creating a diamond structure, e.g. a synthetic diamond structure, on a substrate. Creating a diamond structure may, for example, comprise patterning a diamond seed layer on the substrate. This method comprises obtaining a substrate, providing a mold on the substrate, providing a diamond seed solution in the mold. The method further comprises removing the mold from the substrate such that a diamond structure remains on the substrate.

Referring to FIG. 4, an exemplary method 1 according to embodiments of the present invention is illustrated. This method 1 comprises the step of obtaining 2 a substrate 31, for example on a silicon, silicon oxide (SiOx) or quartz material substrate.

The method 1 further comprises providing 3 a mold 25 on the substrate 31, e.g. transferring a mold 25 atop the substrate 31 or placing the substrate 31 atop the mold 25. This mold may be a microfluidic replica mold from a master template, for example a flexible mold, e.g. an elastomer mold such as a silicone mold. For example, the mold 25 may comprise a silicon elastomer such as polydimethylsiloxane (PDMS). A master template 20 may be used as an imprinting tool for producing the mold, as illustrated in FIG. 3 and discussed further below. The mold 25 may comprise at least one microfluidic channel which is open along the surface for contacting the substrate 31. Thus, when the mold 25 is provided 3 on the substrate 31, the substrate 31 may form a wall section for closing off the at least one microfluidic channel, such that a fluid may be introduced in the microfluidic channel and brought into contact with the portion of the substrate 31 corresponding to this wall section.

In embodiments according to the present invention, providing 3 a mold 25 on the substrate 31 may further comprise covering the mold, e.g. an open mold, with the substrate 31, such that leakage of the diamond seed solution from the mold is avoided.

The method 1 may also comprise a step of creating holes in the mold to create at least one inlet and outlet, e.g. inlets and outlets, for a solution, e.g. the diamond seed solution 34, to be introduced in the mold. For example, at least one microfluidic channel may be formed in the mold for bringing the solution into contact with the substrate as described further below. An inlet and outlet may for example be obtained by puncturing the mold at two ends of the at least one microfluidic channel.

Furthermore, the method 1 comprises providing 4 a diamond seed solution 34 in the mold 25, for example by pumping such diamond seed solution through the at least one microfluidic channel. The diamond seed solution may be a colloidal nanodiamond solution. This providing 4 of a diamond seed solution may comprise pumping the nano-diamond solution through the mold, e.g. through the at least one microfluidic channel. Thus, only selective areas may be seeded without cross-contamination, e.g. the portion of the substrate 31 forming a wall section closing off the at least one microfluidic channel by contacting the mold 25.

In embodiments of the disclosure, the pumping of nano-diamond (ND) solution 34 can either be achieved by mechanical pumping, e.g. by a syringe or a small pump, by spontaneous surface tension confined capillary pumping, or a combination of both. After exposure of the substrate to the ND-solution, ultrapure water may be flushed through for rinsing. Thus the mold 25 may comprise at least one microfluidic channel adapted for spontaneous surface tension confined capillary pumping of the diamond seed solution 34.

Alternatively, in embodiments of the present invention, the diamond seed solution may be transported through the at least one microfluidic channel by applying suction. Thus, an underpressure applied to one end of the at least one microfluidic channel may drain away the diamond seed solution from, for example, a reservoir connected to another end of the at least one microfluidic channel. It is an advantage of such embodiments that improved sealing between the mold 25 and the substrate 31 is achieved by suction applied to the microfluidic system.

The method 1 may furthermore comprise drying the diamond seed solution 34, e.g. by pumping air through the at least one microfluidic channel. Afterwards the mold 25, e.g. the PDMS, may be removed, such that only where the substrate 31 was exposed to the diamond solution 34, diamond seeds 38 remain from which diamond structures can be grown. The most remarkable feature is that in a single step a substrate is patterned with diamond in less 10 minutes and having a materials cost of less than [symbol] 0.30.

The method 1 may further comprise growing 7 a diamond structure on the substrate 31, e.g. in a reactor according to methods for growing diamond on a diamond seed structure as known in the art.

For example, in the pre-growth phase of manufacturing a diamond structure on a substrate, a silicone mold may be used to guide a solution of colloidal nano-diamond over the substrate surface. This may enable the manufacture of patterned diamond in a fast, cheap, highly reproducible, easy-to-use and single-step approach, which produces well-defined diamond structures on the substrate. Furthermore, a master template may be used as an imprinting tool for producing the silicon mold. Once created, this silicon mold can be advantageously used for numerous samples. Also such master template may be reusable, e.g. may be reused for at least more than 65 times, to create new, identical silicon molds.

The method 1 may further comprise fabricating 15 the mold 25, as illustrated in FIG. 3. This fabrication may comprise the step of obtaining a master mold 20 comprising a pattern structure, e.g. a structure patterned in a photo-resist layer, for example a master mold 20 with the desired structures remaining in an epoxy resin. The fabrication may further comprise depositing a flexible material atop structure pattern, e.g. on the photo-resist layer, and removing the flexible material from the master mold 20. Furthermore, the method may comprise a heating step before removing the flexible material from the master substrate 21.

The master mold 20 may thus be used to create a mold 25 for guiding a nano-diamond solution. The silicone mold 25 may be created by depositing a flexible material on the photoresist layer of the master mold 20. For example, the flexible material may be deposited by applying 16 a prepolymer onto the master mold 20, for example by pouring a silicone solution on the master mold 20, and curing 17 the prepolymer, e.g. by a suitable thermal treatment.

Fabricating 15 the mold 25 may comprise removing 18 the flexible material from the master mold 20, for example by peeling off the mold 25, e.g. a silicone mold from the master mold substrate. In embodiments, the mold 25 may be a silicon elastomer such as polydimethylsiloxane (PDMS), which is a material commonly used in microfluidics. PDMS is an optical transparent polymer, consisting of silicon, oxygen and carbon. Apart from its inertness and mechanical properties, the most extraordinary property is the ability of PDMS to be imprinted by any mold down to the sub-microscale. This feature is caused by the viscoelastic nature of the material that allows casting spincoating on a master-mold. After baking, PDMS polymerizes to a solid mass that can be peeled off. At this moment the PDMS may be ready for use.

After peeling 18 off the PDMS mold 25 from the master-mold 20 it may be transferred to the substrate 31. In embodiments of the present invention, holes may be drilled to create at least one inlet and at least one outlet for the nano-diamond solution.

In a method according to embodiments of the present invention, obtaining 10 the master mold 20 may comprise providing a master substrate 21, depositing the photo-resist layer atop the master substrate and patterning the structure in the photo-resist layer.

The master-mold 20 may be obtained 10 with an appropriate technique for the scale intended, as schematically shown in FIG. 2. In embodiments, a substrate 21, e.g. a common substrate such as Si, SiOx, glass or quartz, may be used. The substrate 21 may be spin-coated 11 with a photoresist 22, e.g. a negative epoxy based resin photoresist, e.g. SU-8 2075. After spin-coating 11, a suitable baking process 12 may be applied to the photoresist 22. After the specified baking steps 12, the photoresist 22 may be developed 13, e.g. by exposure to UV-light in a photolithographic processing step or to an electron beam, such that a structure with the desired scale is obtained. The advantage of these techniques is a large dimensional window, ranging from several cm to currently 300 nm. In embodiments, this specific kind of photoresist, e.g. SU-8 2075, can be spin-coated as thick as 2 mm and be cured by optical (UV) lithography, e-beam lithography and even x-ray lithography. Experiments have shown that sub 0.5 μm resolution is possible when using a scanning electron microscope. However, milling, e.g. cnc milling, micromilling and rapid prototyping may be used as well, if the resolution obtainable by such technique meets the intended dimensional requirements of the sample.

After developing 13 and post-exposure baking, a master mold 20 may be obtained with the desired structure pattern remaining in epoxy resin.

Hereinbelow, numerous examples are provided illustrating principles of the present invention, e.g. using micro-fluidic seeding and micro-molds according to embodiments of the present invention. These examples are divided into sub-millimeter scale, micrometer scale and sub-micron scale examples. As characterization tools a combination of scanning electron microscoy (SEM), confocal fluorescence microscopy (CFM) and optical microscopy (OM) are shown in FIG. 9, FIG. 10, and FIG. 11.

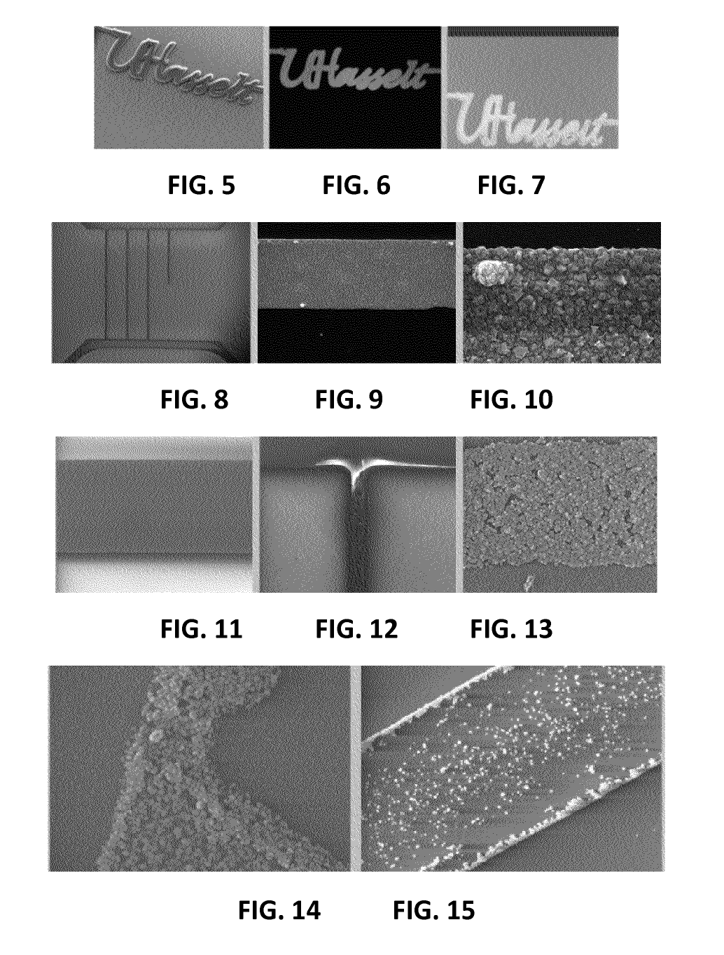

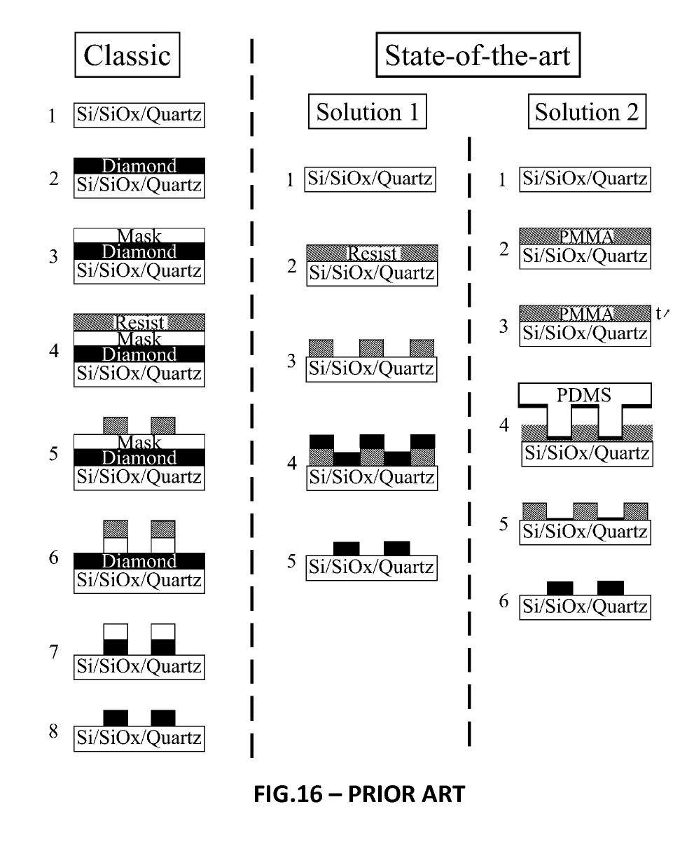

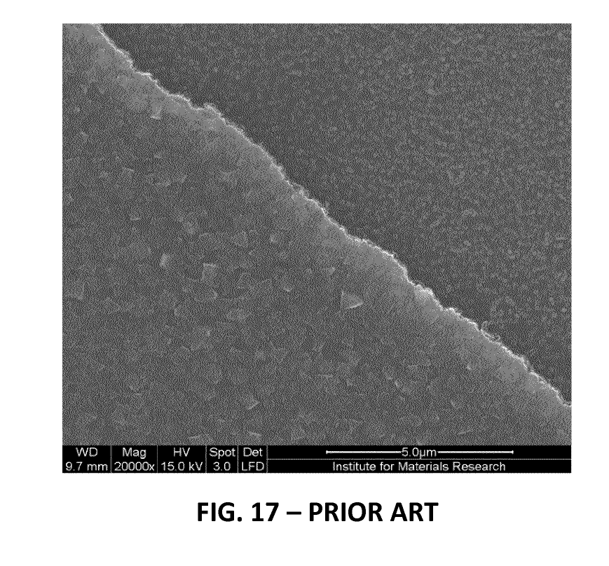

FIGS. 5, 6 and 7 show respectively, SEM, CFM and OM recordings of a sub-millimeter structure. The master mold was made in SU-8 and patterned with e-beam, shown in FIG. 5. In FIG. 6, the PDMS channel was filled with a tracer solution indicating no leakages nor cross-contamination. After flushing diamond seeding solution and growing the diamond structure, the diamond structure shown in FIG. 7 was obtained.

An important range for device application lies within the micrometer range. Here various examples are given of different dimensions of diamond structures. Straight lanes were used to demonstrate the high precision of this technique. In FIG. 8, an overview is given of a seeded surface with a specific pattern. Here, a SEM is shown of a 1 mm long NCD. In FIG. 9, a zoomed image shows a diamond lane with a width of 17 μm. To demonstrate the high resolution aspect of this technique, the well-defined edge of the diamond lane in shown in FIG. 10. The downscaling of structures is shown in FIGS. 11, 12 and 13, with lane widths of 12, 5 and 2 μm respectively. The result from FIG. 13 did not form a continuous diamond structure due to a reduced growth time. This can be seen from the crystal grain sizes when FIG. 13 is compared to FIG. 10. If growth times would be prolonged the film would become continuous. Another important fact is that little or no reseeding is observed.

Furthermore, it is possible to create smaller structures by manipulating the silicon molds, as can be seen in FIG. 14, which shows a 600 nm NCD. In addition, by adjusting the pumping conditions and optimization of the interfacial properties of the liquid and silicone mold, even continuous diamond lanes of 150 nm can be obtained as shown in FIG. 15.

Comparing the methodology according to the present invention to prior art methods, it may be noted that the present method is advantageously fast, offers high resolution, is cheap, can be performed in a single step process, and offers high throughput.

It may even be noted that the construction of a master mold may take about as much time as a single step in any prior art technique described earlier. Yet, once the master mold is created, it can be reused numerous times. As previously mentioned, the silicon mold can be reused which speeds up the production process and reduces the fixed costs. When constructing a single sample, this technique requires about the same time consumption as other known pre-growth approaches. But when multiple samples are required, a possible advantage comes into play with recyclability of the PDMS combined with the high resolution of the technique.

1-11. (canceled)

12. A method for creating a diamond structure on a substrate, the method comprising:
providing a substrate;
providing a mold on the substrate;
providing a diamond seed solution in the mold; and
removing the mold from the substrate such that a diamond structure remains on the substrate.

13. The method according to claim 12, further comprising drying the diamond seed solution before removing the mold from the substrate.

14. The method according to claim 13, further comprising growing the diamond structure in a reactor.

15. The method according to claim 14, wherein providing the mold on the substrate comprises providing the mold including at least one microfluidic channel for contacting the diamond seed solution to the substrate.

16. The method according to claim 15, wherein providing the diamond seed solution comprises pumping the diamond seed solution through the at least one microfluidic channel of the mold.

17. The method according to claim 15, wherein providing the diamond seed solution in the mold comprises providing the diamond seed solution in the mold including the at least one microfluidic channel adapted for spontaneous surface tension confined capillary pumping of the diamond seed solution.

18. The method according to claim 15, wherein providing the diamond seed solution comprises transporting the diamond seed solution through the at least one microfluidic channel of the mold by applying suction.

19. The method according to claim 15, wherein providing the mold on the substrate comprises covering the mold by the substrate to avoid leakage of the diamond seed solution from the mold.

20. The method according to claim 15, further comprising creating holes in the mold to create inlets and outlets for the diamond seed solution to be introduced in the mold.

21. The method according to claim 20, further comprising fabricating the mold, the fabrication comprising:
obtaining a master mold comprising a structure pattern;
depositing a flexible material atop the structure pattern; and
removing the flexible material from the master mold.

22. The method according to claim 21, wherein obtaining the master mold comprises:
providing a master substrate;
depositing a photo-resist layer atop the master substrate; and
patterning the structure in the photo-resist layer.
